(19) United States
(12) Patent Application Publication
(10) Pub. No.: US 2020/0091692 A1
(43) Pub. Date: Mar. 19, 2020

(54) Assembly System Adapted To Assemble A Heat Shrinkable Tube Onto An Electrical Wire

(71) Applicants: Tyco Electronics (Shanghai) Co. Ltd., Shanghai (CN); TE Connectivity Services GmbH, Schaffhausen (CH); Measurement Specialties (Chengdu) Ltd., Chengdu (CN); Shenzhen AMI Technology Co., Ltd., Shenzhen (CN)

(72) Inventors: Fengchun Xie, Shanghai (CN); Dandan Zhang, Shanghai (CN); Roberto Francisco-Yi Lu, Bellevue, WA (US); Lvhai Hu, Shanghai (CN); Qinglong Zeng, Shenzhen (CN); Lan Gong, Chengdu (CN); Qian Ying, Chengdu (CN); Yingcong Deng, Shanghai (CN); Yun Liu, Shanghai (CN)

(73) Assignees: Tyco Electronics (Shanghai) Co. Ltd., Shanghai (CN); TE Connectivity Services GmbH, Schaffhausen (CH); Measurement Specialties (Chengdu) Ltd., Chengdu (CN); Shenzhen AMI Technology Co., Ltd., Shenzhen (CN)

(21) Appl. No.: 16/686,597

(22) Filed: Nov. 18, 2019

Related U.S. Application Data
(63) Continuation of application No. PCT/EP2018/062616, filed on May 15, 2018.

(30) Foreign Application Priority Data
May 18, 2017 (CN) 201710353118.6

(51) Int. Cl. H02G 1/14; G06T 1/00; B29C 61/02; B25J 9/16

(52) U.S. Cl. CPC H02G 1/14; G06T 1/0014; H02G 15/043; B25J 9/1697; B29C 61/02

(57) ABSTRACT

An assembly system includes a feeding mechanism configured to feed a heat shrinkable tube, a cutting mechanism adapted to cut off a segment of heat shrinkable tube from the heat shrinkable tube, a robot adapted to grip the segment of heat shrinkable tube, and a vision system adapted to visually guide the robot to assemble the segment of heat shrinkable tube onto a wire of an electrical product.

### CROSS-REFERENCE TO RELATED APPLICATIONS

This application is a continuation of PCT International Application No. PCT/EP2018/062616, filed on May 15, 2018, which claims priority under 35 U.S.C. § 119 to Chinese Patent Application No. 201710353118.6, filed on May 18, 2017.

### FIELD OF THE INVENTION

The present invention relates to an assembly system and, more particularly, to an assembly system adapted to assemble a heat shrinkable tube onto a wire of an electrical product.

### BACKGROUND

In a field of manufacturing an electrical device, in order to make the electrical device waterproof and insulated, it is often necessary to assemble a segment of heat shrinkable tube onto a wire of an electrical product. The segment of heat shrinkable tube is generally manually assembled onto the wire.

The process of manual assembly of the heat shrinkable tube is as follows: first, cutting off a segment of heat shrinkable tube with a predetermined length from a long heat shrinkable tube; second, heating one end of the segment of heat shrinkable tube with a heating mechanism to melt and seal the one end of the segment of heat shrinkable tube; third, inserting the wire of the electrical product into the segment of heat shrinkable tube through the other end, which is opened, of the segment of heat shrinkable tube, so that the segment of heat shrinkable tube is sleeved onto the wire of the electrical product; and lastly, heating the segment of heat shrinkable tube, which is sleeved onto the wire of the electrical product, with a heater to shrink the segment of heat shrinkable tube on the wire of the electrical product. However, it is time-consuming to manually assemble the segment of heat shrinkable tube with the wire, which reduces the assembly efficiency and assembly accuracy of the segment of heat shrinkable tube.

### SUMMARY

An assembly system includes a feeding mechanism configured to feed a heat shrinkable tube, a cutting mechanism adapted to cut off a segment of heat shrinkable tube from the heat shrinkable tube, a robot adapted to grip the segment of heat shrinkable tube, and a vision system adapted to visually guide the robot to assemble the segment of heat shrinkable tube onto a wire of an electrical product.

### BRIEF DESCRIPTION OF THE DRAWINGS

The invention will now be described by way of example with reference to the accompanying Figures, of which:

FIG. 1 is a perspective view of an assembly system according to an embodiment;

FIG. 2 is a perspective view of a portion of the assembly system; and

FIG. 3 is a sectional side view of a segment of heat shrinkable tube assembled onto a wire of an electrical product.

### DETAILED DESCRIPTION OF THE EMBODIMENT(S)

Exemplary embodiments of the present disclosure will be described hereinafter in detail with reference to the attached drawings, wherein like reference numerals refer to like elements. The present disclosure may, however, be embodied in many different forms and should not be construed as being limited to the embodiment set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

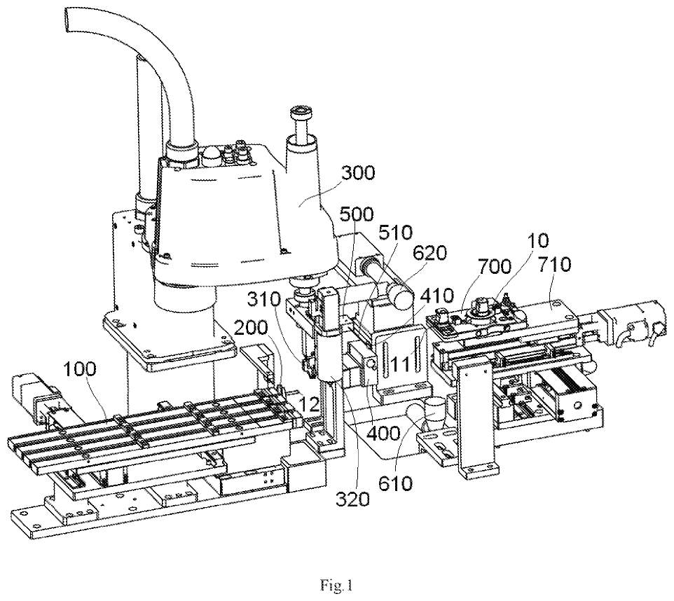

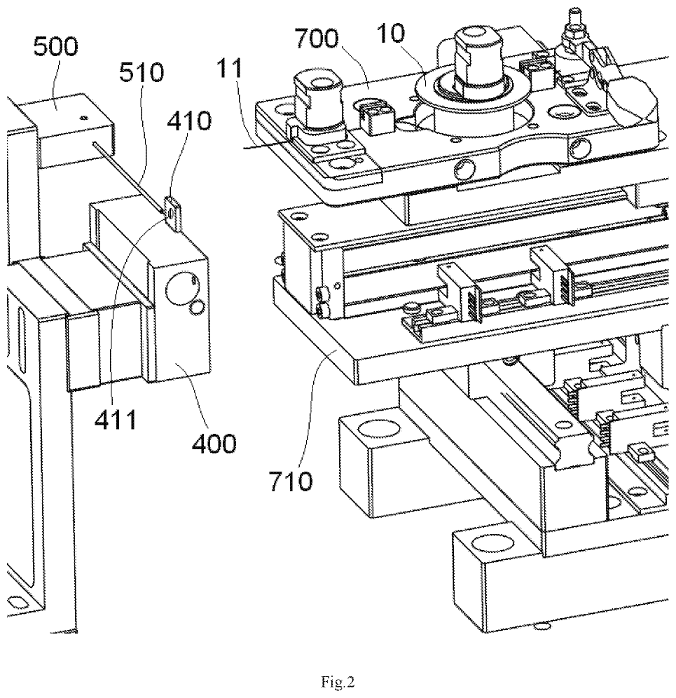

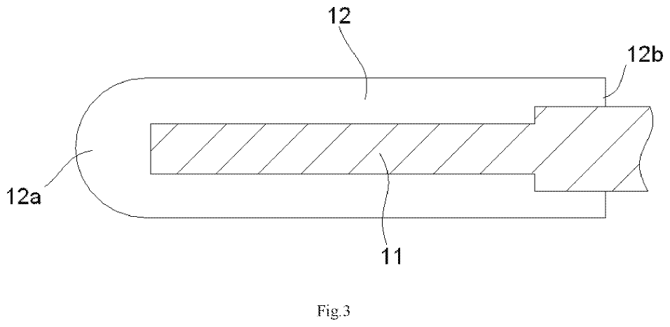

An assembly system according to an embodiment, as shown in FIGS. 1 and 2, includes a feeding mechanism 100, a cutting mechanism 200, a robot 300, and a vision system 610, 620. The feeding mechanism 100 is configured to feed a heat shrinkable tube 12. The cutting mechanism 200 is adapted to cut off a segment of heat shrinkable tube with a predetermined length from the heat shrinkable tube 12 fed by the feeding mechanism 100. The robot 300 is adapted to grip the segment of heat shrinkable tube 12 cut off from the heat shrinkable tube 12. The vision system 610, 620 is adapted to visually guide the robot 300 to assemble the segment of heat shrinkable tube 12 onto a wire 11 of an electrical product 10, as shown in FIG. 3. In an embodiment, the electrical product 10 is a sensor or a connector.

As shown in FIGS. 1 and 2, the assembly system comprises a heating mechanism 400. The heating mechanism 400 is configured to heat a first end 12a of the segment of heat shrinkable tube 12 before assembling the segment of heat shrinkable tube 12 onto the wire 11 of the electrical product 10, so that the first end 12a of the segment of heat shrinkable tube 12 is melted and sealed; that is, so that the first end 12a of the segment of heat shrinkable tube 12 is closed.

As shown in FIG. 3, after the first end 12a of the segment of heat shrinkable tube 12 is melted and sealed, the wire 11 is inserted into the segment of heat shrinkable tube 12 through a second end 12b, which is opened and opposite to the first end 12a, of the segment of heat shrinkable tube 12.

The heating mechanism 400, as shown in FIGS. 1 and 2, a heating body 410. An insertion hole 411 is formed in the heating body 410. The first end 12a of the segment of heat shrinkable tube 12 is adapted to be inserted into the insertion hole 411. The heating body 410 may heat the first end 12a of the segment of heat shrinkable tube 12 by an inner circumferential wall of the insertion hole 411, so that the first end 12a of the segment of heat shrinkable tube 12 is melted and sealed.

The assembly system, as shown in FIGS. 1 and 2, includes a cooling mechanism 500. The cooling mechanism 500 is configured to spray a cooling gas on the first end 12a of the segment of heat shrinkable tube 12 after the first end 12a is heated and melted, so that the first end 12a is quickly cooled and solidified to prevent the first end 12a from breaking. The cooling mechanism 500 includes a gas spray pipe 510 with an outlet located near the insertion hole 411 of the heating body 410. The first end 12a of the segment of heat shrinkable tube 12 is withdrawn from the insertion hole 411 of the heating body 410 immediately after the first end 12a is heated and melted, and is quickly cooled by the cooling gas sprayed from the outlet of the gas spray pipe 510.

The robot 300, shown in FIG. 1, is adapted to insert the first end 12a of the segment of heat shrinkable tube 12 into the insertion hole 411 of the heating body 410 under the guidance of the vision system 610, 620.

The vision system 610, 620, as shown in FIG. 1, includes a first camera 610 and a second camera 620. An optical axis of the first camera 610 is perpendicular to an axis of the insertion hole 411 of the heating body 410. An optical axis of the second camera 620 is perpendicular to the optical axis of the first camera 610 and the axis of the insertion hole 411.

The robot 300 is adapted to assemble the segment of heat shrinkable tube 12 onto the wire 11, as shown in FIG. 3, under the guidance of the vision system 610, 620 after the first end 12a of the segment of heat shrinkable tube 12 is sealed.

The assembly system, as shown in FIGS. 1 and 2, includes a carrier 700 and a moving mechanism 710. The carrier 700 is configured to load and fix the electrical product 10 and the wire 11 of the electrical product 10 thereon. The moving mechanism 710 is adapted to move the carrier 700 and the electrical product 10 fixed on the carrier 700.

As shown in FIG. 1, an iron head 320 is mounted on the robot 300. The robot 300 releases the segment of heat shrinkable tube 12 and pre-heats the segment of heat shrinkable tube 12 with the iron head 320 after the segment of heat shrinkable tube 12 is assembled onto the wire 11, so that the segment of heat shrinkable tube 12 is pre-shrunk on the wire 11 as shown in FIG. 3.

The moving mechanism 710, shown in FIGS. 1 and 2, moves the carrier 700 toward the insertion hole 411 of the heating body 410 under the guidance of the vision system 610, 620 after the segment of heat shrinkable tube 12 is pre-shrunk on the wire 11, so as to insert the segment of heat shrinkable tube 12 into the insertion hole 411 of the heating body 410. The moving mechanism 710 moves the segment of heat shrinkable tube 12 in the insertion hole 411 at a predetermined speed along the axis of the insertion hole 411 to evenly heat the segment of heat shrinkable tube 12 by the inner circumferential wall of the insertion hole 411, until the segment of heat shrinkable tube 12 is completely shrunk on the wire 11. After the segment of heat shrinkable tube 12 is completely shrunk on the wire 11, the moving mechanism 710 moves back the segment of the heat shrinkable tube 12, so that the segment of the heat shrinkable tube 12 is withdrawn from the insertion hole 411 of the heating body 410.

The robot 300, shown in FIG. 1, has multiple degrees of freedom. In an embodiment, the robot 300 may be six-axis robot with six degrees of freedom. A gripper 310 adapted to grip the segment of heat shrinkable tube 12 is mounted on the robot 300.

A process of assembling the heat shrinkable tube 12 onto the wire 11 of the electrical product 10 will now be described in greater detail with reference to FIGS. 1-3.

First, as shown in FIG. 1, the feeding mechanism 100 feeds the heat shrinkable tube 12 to the cutting mechanism 200.

Then, the cutting mechanism 200 cuts off a segment of heat shrinkable tube from the heat shrinkable tube 12 with a predetermined length.

Then, the robot 300 grips the segment of heat shrinkable tube 12 cut off from the heat shrinkable tube 12.

Then, the robot 300 inserts the first end 12a of the gripped segment of heat shrinkable tube 12 into the insertion hole 411 of the heating body 410 under the guidance of the vision system 610, 620 to melt and seal the first end 12a.

Then, the first end 12a of the segment of heat shrinkable tube 12 is quickly cooled by the cooling gas sprayed from the outlet of the gas spray pipe 510 of the cooling mechanism 500.

Then, the robot 300 assembles the segment of heat shrinkable tube 12 onto the wire 11 of the electrical product 10 under the guidance of the vision system 610, 620, and releases the segment of heat shrinkable tube 12.

Then, the segment of heat shrinkable tube 12 is pre-heated by the iron head 320 mounted on the robot 300, so that the segment of heat shrinkable tube 12 is pre-shrunk on the wire 11.

Then, the segment of heat shrinkable tube 12 is inserted into the insertion hole 411 of the heating body 410 with the moving mechanism 710, and is moved in the insertion hole 411 at a predetermined speed along the axis of the insertion hole 411 to evenly heat the segment of heat shrinkable tube 12 by the inner circumferential wall of the insertion hole 411 until the segment of heat shrinkable tube 12 is completely shrunk on the wire 11.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

What is claimed is:

1. An assembly system, comprising:
a feeding mechanism configured to feed a heat shrinkable tube;
a cutting mechanism adapted to cut off a segment of heat shrinkable tube from the heat shrinkable tube;
a robot adapted to grip the segment of heat shrinkable tube; and
a vision system adapted to visually guide the robot to assemble the segment of heat shrinkable tube onto a wire of an electrical product.

2. The assembly system of claim 1, further comprising a heating mechanism configured to heat a first end of the segment of heat shrinkable tube before assembling the segment onto the wire, the heating mechanism melting and sealing the first end of the segment.

3. The assembly system of claim 2, wherein the wire is inserted into the segment through a second end of the segment that is open and opposite to the first end of the segment.

4. The assembly system of claim 3, wherein the heating mechanism includes a heating body having an insertion hole, the first end of the segment is inserted into the insertion hole.

5. The assembly system of claim 4, wherein the heating body heats the first end of the segment with an inner circumferential wall of the insertion hole.

6. The assembly system of claim 5, further comprising a cooling mechanism configured to spray a cooling gas on the first end of the segment after the first end is melted and sealed, the cooling gas solidifying the first end.

7. The assembly system of claim 6, wherein the cooling mechanism has a gas spray pipe with an outlet disposed near the insertion hole of the heating body.

8. The assembly system of claim 7, wherein the first end of the segment is withdrawn from the insertion hole after the first end is melted, and the cooling gas is sprayed by the cooling mechanism after the first end is withdrawn.

9. The assembly system of claim 5, wherein the robot inserts the first end of the segment into the insertion hole under the guidance of the vision system.

10. The assembly system of claim 9, wherein the vision system includes a first camera and a second camera.

11. The assembly system of claim 10, wherein an optical axis of the first camera is perpendicular to an axis of the insertion hole.

12. The assembly system of claim 11, wherein an optical axis of the second camera is perpendicular to the optical axis of the first camera and the axis of the insertion hole.

13. The assembly system of claim 5, wherein the robot assembles the segment onto the wire under the guidance of the vision system after the first end of the segment is sealed.

14. The assembly system of claim 13, further comprising a carrier configured to load and fix the electrical product and the wire of the electrical product.

15. The assembly system of claim 14, further comprising a moving mechanism moving the carrier and the electrical product.

16. The assembly system of claim 15, wherein the robot has an iron head mounted on the robot, the robot releases the segment and pre-heats the segment with the iron head after the segment is assembled on the wire to pre-shrink the segment on the wire.

17. The assembly system of claim 16, wherein the moving mechanism moves the carrier toward the insertion hole under the guidance of the vision system after the segment is pre-shrunk on the wire, the moving mechanism inserting the segment into the insertion hole.

18. The assembly system of claim 17, wherein the moving mechanism moves the segment in the insertion hole at a predetermined speed along an axis of the insertion hole until the segment is shrunk on the wire.

19. The assembly system of claim 1, wherein the robot has a plurality of degrees of freedom.

20. The assembly system of claim 19, wherein the robot has a gripper adapted to grip the segment.
